(19) United States
(12) Patent Application Publication
(10) Pub. No.: US 2024/0319075 A1
(43) Pub. Date: Sep. 26, 2024

(54) LOCAL AREA PHOTOACTIVATION

(71) Applicant: LUMICKS CA HOLDING B.V., Amsterdam (NL)

(72) Inventor: Marinus Theodorus Johannes Van Loenhout, Bussum (NL)

(21) Appl. No.: 18/574,553

(22) PCT Filed: Jul. 1, 2022
(86) PCT No.: PCT/NL2022/050378

§ 371 Date: Dec. 27, 2023

(30) Foreign Application Priority Data
Jul. 2, 2021 (NL) 2028613

(51) Int. Cl. G01N 21/17; G01N 15/10; G01N 15/14

(52) U.S. Cl. CPC G01N 21/1702; G01N 15/14; G01N 2015/1006; G01N 2021/1706

(57) ABSTRACT

A method of manipulating objects is provided which comprises providing a sample holder comprising a holding space for holding an at least partly fluid sample; providing a sample comprising one or more of the objects in a fluid medium in the holding space; controllably causing a local variation of one or more condition for the objects in at least part of the holding space; and removing at least a fraction of the objects from the holding space. The method also comprises the further steps of determining a spatial dependency of the local variation, and phototagging on the basis of the determined spatial dependency at least part of the objects in the holding space in one or more tagging positions thus providing tagged objects, wherein the step of removing at least a fraction of the objects from the holding space comprises removing at least part of the tagged objects.

### CROSS-REFERENCE TO RELATED APPLICATION(S)

This Application is a Section 371 National Stage Application of International Application No. PCT/NL2022/050378, filed Jul. 1, 2022, and published as WO 2023/277691 A1 on Jan. 5, 2023, and further claims priority to Netherlands Patent Application No. 2028613, filed Jul. 2, 2021, the contents of which are hereby incorporated by reference in their entirety.

### TECHNICAL FIELD

The present disclosure relates to a method of handling objects in a sample and a system for performing such method.

### BACKGROUND

The study of cell interactions, e.g. the binding strength of cells on cells is a highly relevant and active research area in biosciences. For example, the avidity characterizes the cumulative effect of multiple individual binding interactions between cells. Similarly, the affinity characterizes the strength with which one molecule binds to another molecule, e.g. the strength with which a receptor on the cell membrane of an immune cell binds to an antigen on the target cell. The avidity and affinity are examples of parameters that play an essential role in the study and development of therapies in medicine, e.g. immune oncology.

A technique for studying interactions between cells is referred to as force spectroscopy. For example, WO 2018/083193 describes a so-called acoustic force spectroscopy (AFS) system that is configured to examine interactions between cells by applying a force to the cells. The system includes a microfluidic sample holder comprising a functionalised wall surface which may include target cells. A plurality of unlabelled effector cells, e.g. T-cells, can be flushed into the microfluidic sample holder, so that they can settle and bind to target cells. Thereafter, an acoustic source is used to exert a ramping force on the bound effector cells so that effector cells will detach from the target cells at a certain force. During this process, the spatiotemporal behaviour of the effector cells in the microfluidic cells is imaged using an imaging microscope. The interaction between cells, e.g. the force at which the effector cells detach, may be determined by analysing the captured (video) images. For example, the cell avidity of the effector cells can be determined this way.

Besides for biological objects such as cells as discussed above, microfluidic sample holders are well known for manipulation of other microscopic objects in fluids.

Microfluidic sample holders tend to have a holding space for holding a sample providing a limited active volume (or interaction volume) where intended manipulation takes place, for example force application. Examples of local force application mechanisms may be e.g. acoustic forces, magnetic forces, dielectrophoretic forces, (shear) flow forces. E.g. in case of biological studies, the interaction volume may also or alternatively be intended for other types of manipulation, e.g. particular types of cell stimulation. For instance, electrodes may be used to electronically stimulate neurons or muscle cells. Chemical interaction with dissolved molecules can also have limited active area where concentration ranges of interest are situated.

In such microfluidic sample holders, the objects may therefore settle upstream and/or downstream of the interaction volume which may lead to undesired and/or uncontrolled interaction. One way to overcome this is using multi-channel geometries with channels that intersect in or near the interaction volume. However, this results in requiring complex fluidics and affecting a shape of the holding space which may in turn affect manipulation properties such as providing distortions of acoustic fields due to the side channels. Another method to overcome these problems is to functionalize specifically the region of interest to target the cells of interest there, this method has the disadvantage that it requires additional process step to achieve selective functionalization, increasing cost and complexity.

Therefore, improved methods and systems are desired as provided herein.

### SUMMARY

In view of the preceding paragraphs, herewith in an aspect, a method of manipulating objects is provided which comprises providing a sample holder comprising a holding space for holding an at least partly fluid sample; providing a sample comprising one or more of the objects in a fluid medium in the holding space; controllably causing a local variation of one or more condition for the objects in at least part of the holding space; and removing at least a fraction of the objects from the holding space. The method also comprises the further steps of: determining a spatial dependency of the local variation, and phototagging on the basis of the determined spatial dependency at least part of the objects in the holding space in one or more tagging positions thus providing tagged objects, wherein the step of removing at least a fraction of the objects from the holding space comprises removing at least part of the tagged objects.

The sample holder may be a microfluidic sample holder which may comprise one or more microfluidic channels fluidly connected with the holding space. Removing at least a fraction of the objects from the holding space may comprise flowing a fluid through the one or more microfluidic channels and in particular through at least part of the holding space.

Controllably causing a local variation of one or more conditions for the objects in at least part of the holding space causes subjecting in at least part of the holding space at least part of the objects in the holding space to the local variation of the one or more conditions. The spatial dependency of the local variation of the at least one condition may comprise one or more of position, size, and shape, in one, two or three dimensions, of the variation, and may relate to temporal variations thereof.

The step of phototagging at least part of the objects in the holding space in one or more tagging positions on the basis of the determined spatial dependency allows recording and determining the positions of the tagged objects relative to the local variation of the one or more conditions. By the phototagging, the tagging position information and therewith spatial information associated with (the spatial dependency of) the local variation is encoded in the objects. The better the condition(s) and the local variation are determined and/or controlled at the time of the phototagging and/or at the tagging position, the better selection and/or analysis of tagged objects further on may be.

The step of phototagging may be performed before, during and after the step of controllably causing the local variation and/or repeatedly as alternating steps. The step of phototagging should preferably be ended prior to the step of removing at least a fraction of the tagged objects from the holding space. The step of phototagging may be short compared to the step of controllably causing the local variation; short may mean less than half, preferably less than a quarter, more preferably less than 10% such as less than 5% or even less than 1% of the duration of the application of the local variation. Then, the phototag may be associated with (presence of an object at) particular momentary conditions, e.g. providing a time stamp.

For sufficiently durable phototags, the position information is detectable also after removal of the tagged objects from the holding space and in particular also after removal from the sample holder. Thus, phototagged objects may be identified and may optionally be selected and/or sorted in a possible subsequent method step from non-tagged or differently tagged objects (see also below).

It is noted that phototagging per se is well known, e.g. for monitoring tissue: Osseiran et al. “Longitudinal monitoring of cancer cell subpopulations in monolayers, 3D spheroids, and xenografts using the photoconvertible dye DiR”, Scientific Reports, 9(1), 1-10, (2019), https://doi.org/10.1038/s41598-019-42165-2, demonstrates a method using DiR for the spatiotemporal labeling of specific cells in the context of cancer cell monolayer cultures, 3D tumor spheroids, and in vivo melanoma xenograft models to monitor the proliferation of cellular subpopulations of interest over time. Turcotte et al, “Intravital multiphoton photoconversion with a cell membrane dye”, J. Biophotonics, 10(2), 206-210 (2017), https://doi.org/10.1002/bio.201600077, describes that photoconversion, an irreversible shift in a fluorophore emission spectrum after light exposure, is a powerful tool for marking cellular and subcellular compartments and tracking their dynamics in vivo. The paper reports on the photoconversion properties of Di-8-ANEPPS. When illuminated with near-infrared femtosecond laser pulse, the characteristic emission spectrum changed from red to blue. The paper shows that the spectral shift is preserved in vivo for hours and allows intravital cell marking and tracking applications.

A quantitative approach is described in Merritt et al. “High multiplex, digital spatial profiling of proteins and RNA in fixed tissue using genomic detection methods”, bioRxiv preprint doi: https://doi.org/10.1101/559021. The paper describes Digital Spatial Profiling (DSP), a non-destructive method for high-plex spatial profiling of proteins and RNA, using oligonucleotide detection technologies with unlimited multiplexing capability. The paper describes how RNA or protein expression of samples can be analyzed by a combination of traditional immune staining and fluorescence microscopy by using photocleavable tags. Based on image analysis, a user can select specific regions of interest from a sample for analysis and release photocleavable tags from these regions of interest for downstream analysis. Because oligonucleotide barcodes can be used as tags/barcodes the approach can be highly multiplexed and many different RNA molecules or proteins can be analyzed in parallel. Detection and quantification of the number of target molecules in each region of interest can be performed by downstream sequencing of the barcodes. The cells themselves of the studied regions of interest are retained in the sample.

Yet another use is described in WO 2020/153837 A1, which discloses a system and method for selecting and isolating single cells by using photo-activation. According to one method, a sample (S) with cells (C) contains a phototagging agent (An). The sample (S) is imaged to identify at least one target cell (Ct) to be isolated. The identified target cell (Ct) in the sample (S) is selectively irradiated with photo-activating light (La) for selectively activating the phototagging agent in the target cell (Ct) to change its fluorescence response (F). The irradiated target cell (Ct) is isolated from other cells in the sample based on a difference in its fluorescence response (F) compared to non-activated phototagging agent (An) in the other cells (C). However, a notable difference between the known phototagging techniques and the presently provided concepts is that in the known techniques, any phototagging is performed on the basis of properties of the studied cells themselves, whereas the present concepts rely on the insight that information related to influences external to the objects—like cells or other type objects—may be recorded in the form of a phototag and thus be carried along together with the respective object. Such external influence may be controlled independently of the object's behaviour and/or may not affect the object and/or may not leave a detectable signature on the object itself otherwise. Phototagging may therefore be used as a tool, which may in a sense be regarded as an administrative tool, for signalling (having been subject to) particular method conditions of/for the object under consideration; the respective tagged objects may thereafter be separated from objects having been subject to different conditions. Phototagging allows identifying objects having been subjected to particular local variations and separating these objects from other objects which were not subjected to the particular local variations, even if the respective objects are identical otherwise. E.g. in the field of microfluidic experiments, objects that settle or otherwise reside in a microfluidic channel upstream or downstream from an interaction area during a period of manipulation in the interaction area may remain unmanipulated. The manipulated objects may be hard to distinguish or separate from the unmanipulated objects after flushing them out of the microfluidic sample holder. In particular for biological cellular bodies, e.g. cells or few-cell objects, the manipulation may comprise stimulation of one or more processes and/or slowing or inhibition of one or more (other) processes. Improved identification of (un-)manipulated cellular bodies can improve analysis of cells and/or cellular interactions.

The method may comprise determining values of the local variation of a condition and the one or more tagging positions may be selected on the basis of a predetermined value and/or range of values. The values and/or tagging positions may be associated with a gradient between at least some of the values, e.g. the condition having, due to the local variation, a first value in a first position and a second, different value in a second position wherein the tagging position may be selected in a third position between the first and second positions and being associated with a third value that is between the first and second values.

As indicated before, in microfluidic methods and experiments, manipulation of objects tends to rely on applied differences in one or more conditions for the objects, the effects of which being only local and/or spatially varying relative to a size of the sample holder and the holding space. Thus, gradients of the manipulation effect tend to occur between a first position where the manipulation and/or the manipulation cause has a first effect, possibly a maximum effect, and a second position where the manipulation and/or the manipulation cause has a second, different effect, possibly a minimum effect, e.g. little or no effect. In one or more further positions between the first and second positions the manipulation and/or the manipulation cause may have one or more intermediate effects. A gradient between values associated with different positions may have a regular, e.g. constant amount of variation, or irregular variation with distance between positions. Determining values of the local variation allows marking the objects having experienced a particular effect (e.g. maximum, minimum, intermediate effect) by selecting the appropriate tagging positions.

The respective first, second and one or more further positions may be specific for one or more of a sample holder, a system comprising the sample holder, a condition for the objects, a manipulation process providing the local variation of the one or more conditions, and the like. In many cases a position and a size of any manipulation effect and any spatial variation therein may be determined accurately by application of the local variation and/or by structural considerations, before and/or during the providing of the local variation associated with the manipulation. Thus, tagging positions may be accurately determined and objects may be tagged prior to and/or during and/or after application of the local variation, associated with particular manipulation properties.

The one or more conditions may comprise one or more of mechanical conditions, electromagnetic conditions, thermal conditions, a concentration of a (bio-) chemical substance including a presence or absence of the substance, and a number or a concentration of objects such as biological objects like cells, antibodies, etc. The local variation may be or provide one or more of: a mechanical force, a pressure force, an acoustic force, an electromagnetic force, a temperature change, a (bio-) chemical reaction trigger, a (bio-) chemical substance concentration variation, and a biological substance concentration variation. The variation may be static or dynamic within a period of interest. The local variation may be configured to induce displacement of at least part of the objects relative to a portion of the holding space. Plural conditions and (effects of) variations may be combined such as an acoustic field providing an acoustic pressure gradient in turn providing an acoustic force for moving one or more of the objects.

The method may comprise phototagging at least some of the objects by altering one or more natural properties of the at least some of the objects. Also or alternatively, the method may comprise providing the objects that are (potentially) to be tagged with one or more tagging substances, preferably one or more optically detectable tagging substances. This may allow detection using a microscopy system and/or a flow cytometry system. Providing the objects with such tagging substance(s) may be referred to as staining the objects. Some detection methods and/or systems, e.g. flow cytometry systems, may be used to sort and/or analyse objects according to an amount of tagging. An amount of tagging may relate to an amount of tagging of an individual object carrying plural phototags and/or to a number of tagged objects.

The one or more tagging substances may have an optical property that may be altered by illumination in one or more predetermined wavelength ranges, more in particular intense light such as laser light. The phototagging then may comprise illuminating the at least part of the objects in the holding space in the one or more tagging positions with light having a wavelength in the one or more predetermined wavelength ranges.

Particularly suitable tagging substances comprise luminescent substances for optical detection, such as dyes. Phototagging and detection of a tag may then comprise illumination, in particular using an optical system to change one or more optical properties of the tagging substance. Therewith, the respective object associated with the tagging substance is marked. Detection may comprise detection of luminescence which may be in response to illumination, possibly in response to the tagging light, wherein for phototagging and detection different amounts and/or intensities may be required and/or used. Phototagging light and/or detection light may pass through at least part of the sample holder, e.g. a window in the sample holder allowing for non-contact tagging. An optical system for phototagging may comprise at least part of a microscopy system.

Luminescence of a tagging substance may rely on fluorescence, phosphorescence, chemiluminescence, bioluminescence, etc. The luminescence and/or dye may be selected for emitting and/or absorbing light in a specific wavelength range that is narrow compared to the wavelength range of visible light, e.g. having an emission spectral bandwidth of about 100 nanometer or less such as 50 nanometer or less, e.g. about 30 or 20 nanometer about a central wavelength, the spectral width may be determined as a Full Width at Half Maximum value (FWHM) of the spectral intensity profile. The central wavelength may be shorter than 11 micrometer, e.g. shorter than 6 micrometer, preferably shorter than 2.5 micrometer such as shorter than 1100 nanometer, more preferably shorter than 800 nanometer; and in a wavelength longer than 250 nanometer, e.g. longer than 300 nanometer, preferably longer than 350 nanometer, more preferably longer than 400 nanometer. Preferably the substance is capable of absorbing visible or near-ultraviolet light (e.g. in a range of 350-700 nanometer) and emitting visible or near-infrared light (e.g. in a range of 450-1500 nanometer).

Changing optical properties of a dye may include photobleaching, photoactivation, and/or photoconversion. Photobleaching may be reversible or irreversible, at least on time scales of interest, wherein irreversible photobleaching may also include destroying a dye particle (“particle” here meaning molecule, complex, moiety, etc. providing the optical effect) and/or removing a dye particle by photo-cleaving of a linker by which the dye particle is attached. Photoactivation may cause functioning of the dye, e.g. “turning the dye on”, and/or may comprise synthesis of a dye particle and/or removing part of a luminescence-blocking structure resulting in a desired dye particle. Photoconversion may cause a change in at least some emission properties of the dye, e.g. emission- and/or absorption-color changing of the dye, and may comprise a combination of photobleaching and photoactivation. Suitable dye molecules may be comprised in an interaction moiety for (bio-) chemical attachment to the object. E.g., the method may comprise providing at least some of the objects with an optically modifiable moiety.

Photoconversion of a dye may allow for measurement of a ratio of photoconversion between two or more emission properties, typically different wavelength ranges, instead of measurement of raw intensity in one or more wavelength ranges. Thus, noise due to differences in absolute brightness between objects may be reduced. E.g. differences in an amount of staining of objects (some objects containing more dye molecules or higher concentrations of dye molecules than others) may not or at least to a lesser degree affect the measurement in case the measurement is ratiometric.

The method may comprise providing at least part of the objects with one or more tagging substances enabling independent and/or multiple phototagging, and phototagging on the basis of the determined spatial dependency one or more of the objects provided with one or more tagging substances plural times and/or on plural tagging positions.

This allows tagging and/or identifying the objects with markers according to different conditions and/or different values of the local variation in the respective condition(s).

Such method may comprise providing the objects with a plurality of identical tagging substances for identification on the basis of luminescent power from the object, e.g. associated with luminescence of the number of times the object is phototagged and/or the number of tagging substances affected. Thus, a brightness and/or a ratio of the luminescence of an object may be related to a total dose of the photoactivation light received by the object.

Such method may comprise providing the objects with a plurality of different tagging substances each having one or more different phototagging requirements such as differences with respect to one or more of wavelength, wavelength combination, illumination intensity, illumination duration, illumination energy, polarization, etc. Independent phototagging may comprise phototagging with plural, different controllable operations, in particular comprising one or more dyes susceptible for photobleaching, photoactivation, and/or photoconversion by electromagnetic radiation of different wavelength ranges, e.g. ultraviolet and yellow light, respectively. Thus, multiple fractions of objects may be uniquely marked by the use of multiple dyes with different activation properties and/or by using distinct levels of activation, bleaching, or photo conversion.

According to the present concepts, the phototagging is positional, applying phototagging in one or more tagging positions. E.g. marking one or more desired objects and/or objects in particular tagging positions, e.g. cells in an interaction region, by changing optical properties of the dye. Thus, the objects may be colour coded between tagged and non-tagged objects.

Any embodiment of the method may comprise that the step of phototagging is performed prior to a step of controllably causing a local variation of one or more conditions for the objects in at least part of the holding space. Also or alternatively, the steps of phototagging and the step of controllably causing a local variation of one or more conditions for the objects in at least part of the holding space may be performed at least in part simultaneously. The step of controllably causing a local variation of one or more conditions for the objects in at least part of the holding space controllably causes subjecting in at least part of the holding space at least part of the objects in the holding space to the local variation of the one or more conditions.

Thus, the objects are marked according to (the spatial dependency of) the local variation they will be, and/or are, and/or have been subjected to in the sample holder, which may be in accordance with characteristics of the sample holder and/or associated parts of a manipulation system provided with the sample holder.

The step of causing a local variation one or more conditions may comprise subjecting the objects to a driving force for displacing at least some of the objects with respect to the holding space. The driving force may select between objects for which the driving force is sufficient or not to displace the respective object; this may depend on several factors such as one or more of susceptibility of the object to the driving force, adhesion of the respective object to part of the holding space, motion resistance of the respective object against part of the holding space, flow resistance of the respective object to the fluid of the sample, which may depend on size and/or shape of the respective object. Such driving force may be provided, at least in part, by microfluidic flow in at least part of the holding space, which may comprise a shear flow and/or a sheath flow of a sample fluid or other fluid such as for flow focusing. The driving force may be configured for urging the objects in a direction away from a functionalised wall surface portion when provided. In particular, the driving force may be provided, at least in part, by an acoustic force.

The step of causing a local variation of one or more of the conditions may comprise applying an acoustic wave in the sample holder for applying an acoustic force to the at least part of the objects in the holding space. In particular this may comprise applying the acoustic wave in the sample holder for applying an acoustic force for urging at least part of the objects away from a wall surface of the holding space, which may in particular comprise urging at least part of the objects away from a functionalised wall surface portion. Such acoustic force may be a driving force for displacing at least some of the objects with respect to the holding space. Acoustic forces have proven to allow very effective controllable manipulation of microfluidic objects, such as biological objects more in particular cellular objects like cells; also compound objects such as multicellular objects and/or complexes of a biological object and a microsphere. Such acoustic force may allow acoustic force spectroscopy as indicated before. Use of a functionalised wall surface portion facilitates use and/or study of (bio-)chemical interactions.

The method may comprise determining an active area in the holding space and determining one or more tagging positions in the active area, which may comprise restricting the one or more tagging positions to at least part of the active area. The active area may be determined by a manipulation source, e.g. an acoustic wave generator such as a transducer, which may comprise a piezo element. Any method embodiment may comprise a calibration step comprising determining and/or selecting an optimal active area for a particular manipulation. E.g. in case the local variation provides a force, an area where a force is above a threshold or an area of substantially homogeneous force may be selected. The active area may be determined and/or selected associated with one or more properties of the sample holder and/or a system comprising the sample holder. E.g. different devices of the same basic design may still provide variations in one or more of location, size, distribution and effectiveness of the active area. A system may be configured to take into account calibration data for determining the area and/or pattern of activation.

Also or alternatively, the holding space may comprise a holding space depth and the method may comprise defining one or more tagging positions in a predetermined depth or range of depths within the holding space depth which may comprise restricting the one or more tagging positions to the predetermined depth or range of depths. This allows phototagging on the basis of a position and/or displacement of objects within a volume of the holding space.

In combination, the tagging positions may be defined in one or more volume fractions selected within the holding space.

The method may comprise repeating one or more times the steps of causing a local variation of one or more of the conditions for the objects in at least part of the holding space, and removing at least a fraction of the objects from the holding space, wherein the step of phototagging is executed in between and/or during at least some successive instances of performing the steps of causing a local variation, e.g. before each repetition. Then, in at least one repetition the step of causing a local variation of one or more of the conditions for the objects in at least part of the holding space preferably differs from a preceding execution of the step. The difference preferably relates to a value of the local variation, more in particular a magnitude of the condition, e.g. repetitions may differ in a magnitude of a driving force applied to at least part of the objects in the holding space in the respective repetition. In such case, effects of the magnitude of the condition may be probed accurately. Other examples of suitable differences may comprise a presence and/or an absence and/or a different magnitude of electrical or chemical fields which may cause stimulation and/or suppression of one or more biological processes. Also or alternatively, an example may comprise subjecting at least part of the objects to different pressures.

At least part of the method may be performed using a computer. In particular a computer implemented method of manipulating objects in a fluid medium is provided, comprising the steps of:
receiving data representing one or more conditions for objects in a fluid medium in a holding space of a sample holder;
receiving data representing a local variation in the one or more conditions for the objects in the holding space;
determining a spatial dependency of the local variation;
determining on the basis of the determined spatial dependency one or more tagging positions for at least part of the objects in the holding space;
providing a control signal for a controllable light source for phototagging at least part of the objects in the holding space in the one or more tagging positions thus providing tagged objects;
providing a control signal for an actuator for controlling a fluid flow through the holding space for removing at least a fraction of the tagged objects from the holding space.

The data representing one or more conditions for objects in a fluid medium in a holding space of a sample holder, and/or the data representing a local variation in the one or more conditions for the objects in the holding space may be acquired by and/or derived from one or more sensors and/or from one or more control systems for controlling at least part of the sample holder and/or a system comprising the sample holder.

In particular, the condition may be or be associated with a pressure in the holding space and the local variation may be or be associated with a pressure gradient due to spatial variations in a pressure, possibly due to a finite size of a pressure generator, resulting in a spatial variation of a force urging at least some of the objects in a particular direction, which may be referred to as a pressure- and/or force profile, which may be at least in part calculated and/or which may be at least in part determined as part of the method, and/or which may be calculated and/or determined beforehand as a characteristic of the sample holder and/or of a system comprising the sample holder.

Also, or alternatively, a spatial temperature profile may be determined in the sample fluid, which may be detected by a thermal sensor. A concentration profile may e.g. be determined by an optical method.

Further an associated data processing apparatus comprising means for carrying out any of the computer implemented method; a computer program comprising instructions which, when the program is executed by a computer, cause the computer to carry out the method; and a computer-readable medium having stored thereon the computer program, are provided.

In aspect herewith is provided a system for performing any method embodiment provided herein. The system comprises
a sample holder comprising a holding space for holding an at least partly fluid sample comprising one or more objects;
an acoustic wave generator connectable or connected with the sample holder to generate an acoustic wave in the holding space exerting a force on at least part of the sample;
a fluid supply for supplying at least part of an at least partly fluid sample to the holding space and/or for removing at least a fraction of the at least partly fluid sample from the holding space, and
a light source for phototagging sample objects in the sample fluid in the holding space in one or more tagging positions thus providing tagged objects.

The sample holder may be a microfluidic sample holder. The light source may provide light in one or more infrared, visible and/or ultraviolet wavelengths or wavelength ranges, e.g. comprising laser light and/or LED light. The light source may comprise one or more optical elements defining an optical beam path extending into or through the holding space, which may at least partly overlap another illumination light path and/or a detection optical light path, possibly through one or more polychroic mirrors and/or beam splitters. The fluid supply may comprise one or more of pumps, conduits, reservoirs, valves, splitters, etc.

In the system the sample holder may comprise a wall providing the holding space with a functionalised wall surface portion to be contacted, in use, by at least part of the sample. Also or alternatively, the acoustic wave generator may be configured to exert a force on the one or more cellular bodies of the sample in the holding space, when comprised in the holding space, in a direction away from a wall of the holding space. In particular the acoustic wave generator may be configured to exert the force in a direction away from the functionalised wall surface portion, when provided. Thus, adhesion of sample objects to the wall may be probed.

The system may comprise an optical detector for optically detecting at least some objects of the sample in the holding space. The optical detector may comprise or be part of a microscope, and/or it may comprise a camera such as a digital video camera. The apparatus may comprise the data processing apparatus described herein elsewhere.

The currently provided concepts are based on the insight that known cell-adhesion assays and methods that aim for analysing cell-surface biomolecule composition and abundance, require a large quantity of cells, are very laborious and depend on expensive instrumentation. Furthermore, these known techniques typically lack the ability to assess cell-adhesion forces and cell-adhesion kinetics, in particular at the single cell level.

The presently provided method enables improved studies on the various properties of multiple individual cellular bodies in parallel, e.g. since multiple cellular bodies in the sample may contact and interact with a functionalised wall surface portion. This may increase accuracy of the study results and false positives or false negatives may be avoided. The presently provided methods may enable studies on cellular bodies per se, without requiring adhesion of foreign objects to the cellular bodies such as microbeads, magnets, antibodies, etc., other than one or more phototagging substances if the object itself is not suitable for phototagging. Phototagging substances may be detachable from an object which may be without remnant to the object. Thus, the cellular bodies may remain essentially unharmed by the present method and it is envisioned that after performing the method, the cellular bodies could be administered to a test subject and/or returned to a subject having donated the cellular bodies for studying; e.g. one or more of T-cells, leukocytes, erythrocytes and similar cellular bodies may be withdrawn from a subject, be studied in accordance with one or more method embodiments, and could thereafter be further analysed with various other methods (single-cell sequencing, fluorescence microscopy, cryo-electron microscopy, etc.) and/or administered to another subject (e.g. blood donation) or returned to the original subject itself. In an embodiment comprising a functionalised wall surface layer and cellular bodies as particles, one of the cellular bodies and functionalised wall surface layer may comprise effector cells and the other one of the cellular bodies and functionalised wall surface layer comprises target cells. Such embodiment may further comprise determining a binding characteristic of the effector cells to the target cells.

In a particular embodiment, one of the cellular bodies and functionalised wall surface layer comprises immune cells and the other one of the cellular bodies and functionalised wall surface layer comprises tumor cells. One particular example of the method is the accurate measurement of the intercellular binding strength of immune cells (e.g. T-Cells, CAR-T cells, NK cells, CAR-NK cells, etc.) to their target cells (e.g. tumor cells, virus infected cells, etc.).

Suitable dyes for use as phototags for live cells include but are not limited to: DIR, Di-8-ANEPPS, PA Janelia Fluor@ 549, PA Janelia Fluor@ 646, or DACT (see e.g. Carlson et al., 2013; Grimm et al., 2016; Halabi et al., 2020; Osseiran et al., 2019; Turcotte et al., 2017; referred to above)

### BRIEF DESCRIPTION OF THE DRAWINGS

The above-described aspects will hereafter be more explained with further details and benefits with reference to the drawings showing a number of embodiments by way of example.

FIG. 1 schematically shows a manipulation system;

FIG. 2 is a cross section of a sample holder;

FIG. 2A is a detail of the sample holder of FIG. 2 as indicated with “IIA”;

FIG. 3 is a partial and schematic top view of a sample holder comprising a sample with a number of objects in a sample fluid;

FIGS. 4A-4E schematically indicate several exemplary method steps:

FIGS. 5A-5B and 6A-6B indicate different methods of phototagging objects in particular tagging positions.

### DETAILED DESCRIPTION OF EMBODIMENTS

It is noted that the drawings are schematic, not necessarily to scale and that details that are not required for understanding the present invention may have been omitted. The terms “upward”, “downward”, “below”, “above”, and the like relate to the embodiments as oriented in the drawings, unless otherwise specified. Further, elements that are at least substantially identical or that perform an at least substantially identical function are denoted by the same numeral, where helpful individualised with alphabetic suffixes.

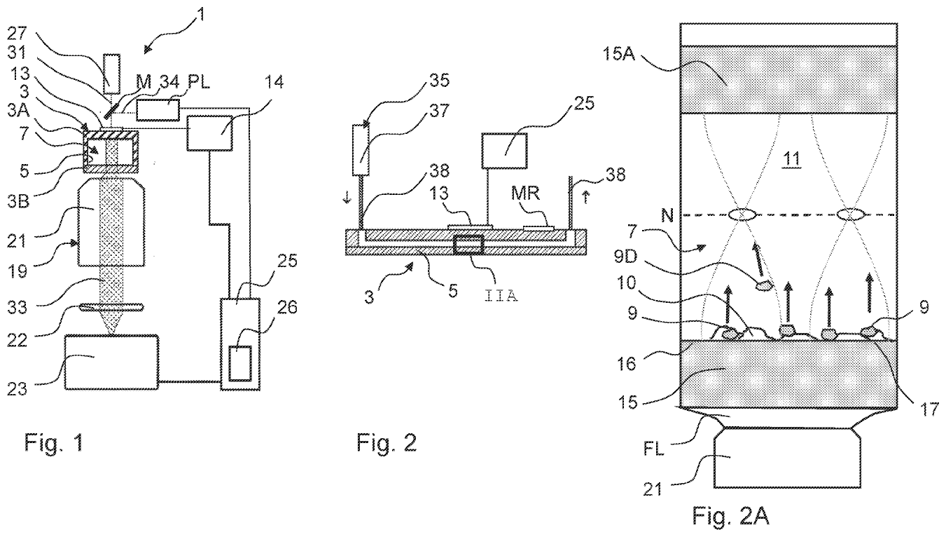

FIG. 1 is a schematic drawing of an embodiment of a manipulation system 1 in accordance with the present concepts, FIG. 2 is a cross section of a sample holder and FIG. 2A is a detail of the sample holder of FIG. 2 as indicated with “IIA”.

The system 1 comprises a microfluidic sample holder 3 comprising a holding space 5 for holding a sample 7 comprising one or more objects, in particular biological cellular bodies 9, in a fluid medium 11 as exemplary particles of interest. It is noted that also, or alternatively, other types of particles like microspheres could be used, possibly attached to biological cellular bodies 9. The fluid preferably is a liquid or a gel. The system 1 further comprises, as one example of a source of a local variation in a condition for the sample objects 9, an acoustic wave generator 13, e.g. an acoustic transducer possibly comprising a piezo element, the generator being connected with the sample holder 3 to generate an acoustic wave in the holding space 5 exerting a force on the sample 7 and cellular bodies 9 in the sample 7. The acoustic wave generator 13 is connected with an optional controller 14 and power supply, here being integrated.

The sample holder 3 comprises a wall 15 providing the holding space 5 with a functionalised wall surface portion 17 to be contacted, in use, by part of the sample 7. A further wall, e.g. opposite wall 15A, may also or alternatively be provided with a (further) functionalised wall surface portion.

The shown manipulation system 1 comprises a microscope 19 with an objective 21 and a camera 23 connected with a computer 25 comprising a controller and a memory 26. The computer 25 may also be programmed for tracking one or more of the cellular bodies based on signals from the camera 23 and/or for performing microscopy calculations and/or for performing analysis associated with (superresolution) microscopy and/or video tracking, which may be sub-pixel video tracking. The computer or another controller (not shown) may be connected with other parts of the system 1 (not shown) for controlling at least part of the microscope 19 and/or another detector (not shown). In particular, the computer 25 may be connected with one or more other parts of the system such as the acoustic wave generator 13, the power supply thereof, the controller 14 thereof (both as shown in FIG. 1), a temperature control, sample fluid flow control, etc. (none shown) and a light source (see below).

The system comprises a light source 27. The light source 27 may illuminate the sample 7 using any suitable optics (not shown) to provide a desired illumination intensity and intensity pattern, e.g. plane wave illumination, Köhler illumination, etc., known per se. Here, in the system light 31 emitted from the light source 27 is directed through the acoustic wave generator 13 to (the sample 7 in) the sample holder 3 and sample light 33 from the sample 7 is transmitted through the objective 21 and through an optional tube lens 22 and/or further optics (not shown) to the camera 23. The objective 21 and the camera 23 may be integrated. In an embodiment, two or more optical detection tools, e.g. with different magnifications and/or components related to spectral and/or polarization properties, may be used simultaneously for detection of sample light 33, e.g. using a filter and/or a beam splitter.

In another embodiment, not shown but discussed in detail in WO 2014/200341, the system comprises a partially reflective reflector and light emitted from the light source is directed via the reflector through the objective and through the sample, and light from the sample is reflected back into the objective, passing through the partially reflective reflector and directed into a camera via optional intervening optics. Further embodiments may be apparent to the reader.

The sample light 33 may comprise light 31 affected by the sample (e.g. scattered and/or absorbed) and/or light emitted by one or more portions of the sample 7 itself e.g. by chromophores and/or fluorophores attached to the cellular bodies 9.

Some such chromophores and/or fluorophores attached to the cellular bodies 9 may be used for phototagging.

Further, the system 1 comprises a phototagging light source PL, e.g. a laser and/or a non-laser light-emitting diode (LED). Phototagging light 34 emitted from the phototagging light source PL is directed through the acoustic wave generator 13 to (the sample 7 in) the sample holder 3. Here, as an option the system light 31 and the phototagging light 34 are directed by and through, respectively, a dichroic mirror M. However, other optical paths may be provided, see also below. The phototagging light source PL preferably is connected with one or more other parts of the system such as the computer 25 (as shown in FIG. 1) and/or one or more of the acoustic wave generator 13, the power supply thereof, the controller 14 thereof, the light source 27, a temperature control, sample fluid flow control, etc. (not shown).

Some optical elements in the system 1 may be at least one of partly reflective, polychroic like dichroic (having a wavelength specific reflectivity, e.g. having a high reflectivity for one wavelength and high transmissivity for another wavelength), polarisation selective and otherwise suitable for the shown setup. Further optical elements e.g. lenses, prisms, polarizers, diaphragms, reflectors etc. may be provided, e.g. to configure the system 1 for specific types of microscopy.

The sample holder 3 may be a microfluidic sample holder. The sample holder 3 may be formed by a single piece of material with a channel inside, e.g. glass, injection moulded polymer, etc. (not shown) and/or by fixing different layers of suitable materials together more or less permanently, e.g. by welding, glass bonding, gluing, taping, clamping, etc., such that a holding space 5 is formed in which the fluid sample 7 may be contained, at least during the duration of an experiment. As shown in FIGS. 1 and 2, the sample holder 3 may comprise a part 3A that has a recess being, at least locally, U-shaped in cross section and a cover part 3B to cover and close (the recess in) the U-shaped part providing an enclosed holding space 5 in cross section. A monolithic sample holder, at least at the location of the acoustic wave generator 13, may be preferred over an assembled sample holder for improving acoustic coupling, reducing losses and/or preventing local variations.

As shown in FIG. 2, the sample holder 3 is connected to an optional fluid flow system 35 for introducing fluid into the holding space 5 of the sample holder 3 and/or removing fluid from the holding space 5, e.g. for flowing fluid through the holding space (see arrows in FIG. 2). The fluid flow system 35 may comprise a manipulation and/or control system, possibly associated with the computer 25. The fluid flow system 35 may comprise one or more of reservoirs 37, pumps, valves, and conduits 38 for introducing and/or removing one or more fluids, sequentially and/or simultaneously. The sample holder 3 and the fluid flow system 35 may comprise connectors, which may be arranged on any suitable location on the sample holder 3, for coupling/decoupling without damaging at least one of the parts 3, 35, and preferable for repeated coupling/decoupling such that one or both parts 3, 35 may be reusable thereafter. Further, an optional machine-readable mark MR or other identifier is attached to the sample holder 3, possibly comprising a memory.

FIG. 2A is a schematic of a number of cellular bodies 9 in the sample holder 3 of FIG. 2. Part of the surface 16 of the wall 15 of the sample holder 3 is optionally provided with a functionalised wall portion 17, e.g. an area of the wall 15 being covered with biological cells 10 of a different type to which the objects of interest, here cellular bodies 9 may adhere. Also shown is part of the microscope lens 21 and an optional immersion fluid layer FL for improving image quality.

On providing a periodic driving signal to the acoustic wave generator 13 a standing wave is generated in the sample holder 3. The signal may be selected, as indicated, such that an antinode of the wave is generated at or close to the wall surface (of the sample holder 3 e.g. functionalised wall surface portion 17) and a node N of the wave W away from the surface 16, generating a local maximum force F on the bodies 9 at or near the surface towards the node. Thus, application of the signal may serve urge the bodies 9 away from (the surface 16 of) the wall 15 and to the node N to probe adhesion of the bodies 9 to the surface of the wall 15 and/or any functionalized layer on it in dependence of the force F.

In an example an optimal force generation for particular studies may be achieved by selecting acoustic cavity parameters and the frequency/wavelength of the acoustic wave in order to create a maximum pressure gradient at the wall surface, e.g. by ensuring that the distance from the wall surface to the acoustic node is approximately ¼ wavelength.

Thus, the acoustic force may be configured to induce displacement of at least part of the objects 9 relative to a portion of the holding space 5, which displacement may be related to detachment from the functionalized wall surface portion 17; the displacement or not of individual objects 9 is dependent on whether the acoustic force F is stronger than the binding force of the object 9 to (objects 10 on) the (functionalized wall surface portion 17 of) the wall 5. A fluid flow, during or shortly after application of the acoustic wave (in particular before detached objects 9D have had the opportunity to fall back and settle and/or (re-) attach to (a surface of) the wall 5) may be used to remove at least part of the detached objects 9D from the holding space 5. Note that the force F may be, and generally is, position specific along (the surface of) the wall 5 so that the magnitude of the force experienced by plural objects 9 may differ between these objects; thus detachment of objects bound equally strong to the functionalized wall surface may detach or not differently depending on their position and the magnitude of the acoustic detachment force at that position.

The functionalized may comprise one or more interaction moieties for interacting with a cellular body. In particular the functionalized wall surface portion 17 may be provided with one or more substances comprising at least one of antibodies, peptides, biological tissue factors, biological tissue portions, bacteria, antigens, proteins, ligands, cells, tissues, viruses, (synthetic) drug compounds, lipid (bi)layers, fibronectin, cellulose, nucleic acids, RNA, small molecules, allosteric modulators, (bacterial) biofilms, “organ-on-a-chip”, etc., and/or specific atomic or molecular surface portions (e.g. a gold surface) to which at least part of the sample tends to adhere with preference relative to other surface portions. Using such functionalized wall surface portion, affinity of a biological cellular body to the functionalized may be probed.

Displacement of a particle 9 may be detected via the microscope using known image capturing techniques including video and/or other time-resolved methods (e.g. methods such as described in WO 2014/200341). Spatiotemporal displacement properties of a particle 9 through the sample fluid may be determined on the basis of the Navier-Stokes equations for the specific particle shape and size in combination with the properties of the fluid 11, e.g. see D. Kamsma “Acoustic Force Spectroscopy (AFS)—From single molecules to single cells”, PhD-thesis Vrije Universiteit Amsterdam, ISBN: 978-94-028-1009-7. By detecting the displacement velocity of a particle 9 the acoustic force may be determined; note that the same may hold for any lateral displacement of the particle 9. Using multiple test particles such as microbeads and/or repetitive measurements on one or more test particles, an acoustic force in plural positions in the holding space distributed in one or two directions perpendicular to the acoustic force direction may be determined. Thus, spatial variations in an acoustic force field in a sample holder may be determined, also independent from objects under study. A thus-determined spatial variation may be used for determining spatial extent and/or values of a local variation of the acoustic field and/or of the acoustic force, and/or it may be used for the determination of the tagging positions.

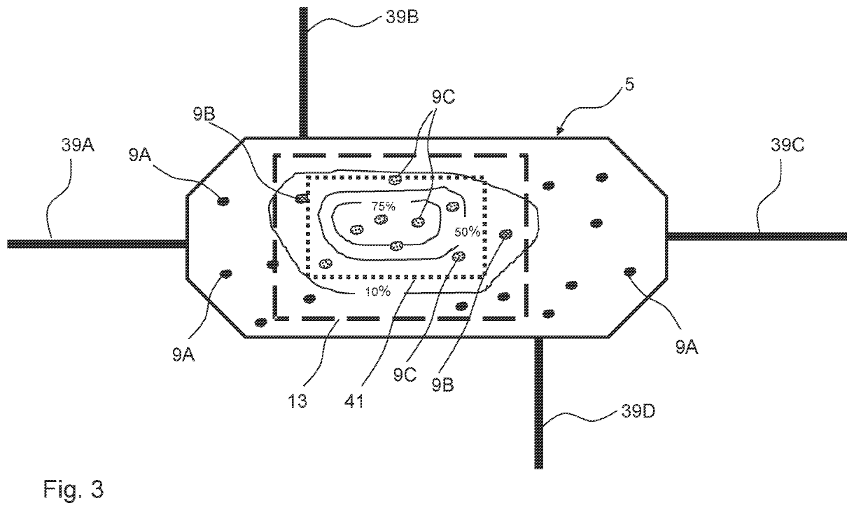

FIG. 3 is a partial and schematic top view of a sample holder 3 comprising a sample with a number of objects 9A-9C in a sample fluid 11 in the holding space 5. Microfluidic channels 39A-39D are fluidly connected with the holding space 5 for supplying at least part of the sample to the holding space 5 and/or for removing at least a fraction of the sample from the holding space 5. An acoustic wave generator 13 is connected with the sample holder 3. Generation of an acoustic wave in the holding space 5 causes a force urging the objects in at least part of the holding space away from the wall (cf. FIG. 2A). E.g. as described in the preceding paragraphs, a spatial dependency of the force field may be determined. The acoustic force may be limited to only part of the holding space and/or may be uneven across the holding space. An exemplary (simulated) distribution of the resultant acoustic force is indicated by contour lines of force strength, which shows that the force is localised within the holding space 5 and spans only a fraction of the holding space 5. By consequence, objects 9B-9C (dotted) are subjected to the acoustic force to a certain amount and objects 9A (black) are substantially unaffected by the force. Note that in practice an acoustic force field may, and generally will, span across a larger area of a holding space and/or may be significantly more homogeneously distributed than shown in FIG. 3.

An active area 41 of the force field may be selected as indicated, wherein the force is considered suitable according to particular experimental criteria; the active area may be smaller, larger, and/or shaped differently than the one shown in FIG. 3, e.g. being shaped more in accordance with a force contour and/or with one or more other criteria; objects 9C in the active area are phototagged using suitable illumination from the phototagging light source PL. Hence, tagging positions for tagging the objects 9C are selected on the basis of the determined spatial dependency of the acoustic force. Thus tagged objects 9C are provided.

Phototagging objects that have been subject to one or more particular condition may be referred to as “positive phototagging”. Also or alternatively, negative phototagging could be used. E.g. one could phototag all objects outside of an area of interest and thereby distinguish untagged objects (which experienced the changed condition) from tagged objects (which did not experience the condition). Negative and positive phototagging could be combined, in particular when using a first phototag for the positive phototagging and a second, different, phototag for the negative phototagging, and/or for sequential applications of one or more local variations wherein different instances of application allow distinguishing between positively and negatively tagged objects.

Note that, once the contours of the force are determined their position and relative values may usually be considered constants for the sample holder and acoustic wave generator 13, whereas the absolute value of the force at a given position in the holding space may depend on the absolute acoustic power supplied to the sample holder. Thus, objects residing in particular positions in the holding space may be phototagged prior to actually applying the acoustic force, knowing that the objects will be subjected to a particular (relative) force strength at the selected phototagging positions. For the phototagging the entire active area may be illuminated and/or at least some objects 9C in the area of interest may be phototagged individually and/or as a group, e.g. depending on optical control over the phototagging light and/or particular selection criteria and/or other factors.

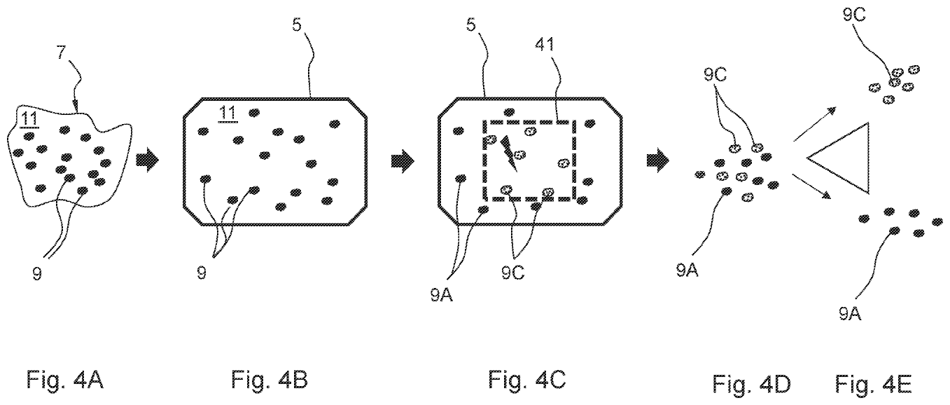

Also or in addition, one or more of an electric field, a magnetic field, a fluid supply from one or more of the channels 39A-39D and/or a fluid flow through the holding space 5 (which may be too little to displace the objects) may provide a similar local variation of conditions for the objects 9A-9C in the holding space 5. FIGS. 4A-4E schematically indicate several exemplary method steps: FIG. 4A indicates providing a sample 7 comprising one or more of the objects 9 in a fluid medium 11; the objects 9 here are cells. The cells are, as an option, pre-incubated with a photoactivatable/convertible dye (this procedure may be called “staining”). Suitable dyes may be DiR, Di-8-ANEPPS, PA Janelia Fluor@ 549, PA Janelia Fluor@ 646, and/or DACT, each known and commercially available. FIG. 4B indicates providing the sample 7 into the holding space 5 of a sample holder by a fluid flow through microfluidic channels and through the holding space, cf. FIGS. 1-2 and 3. Then, the sample may be left to incubate and/or react with a functionalized wall surface portion in the holding space, when provided. Also, other sample preparation manipulation may be performed.

FIG. 4C indicates performing an assay; this comprises the steps of controllably causing a local variation of one or more conditions for the objects 9 in at least part of the holding space 5 and determining a spatial dependency of the local variation, see also FIG. 3; associated with the assay, cells 9 in a selected active area 41 are photoactivated at a specific time, thus phototagging these cells providing tagged objects 9C on the basis of the determined spatial dependency in tagging positions defined by the active area 41.

The tagging positions may be selected as a region of interest which may be defined by a simple mask. Also or alternatively, specific cells may be targeted by a focused phototagging beam and/or via adaptive optics, e.g. using a spatial light modulator or beam steering optics (see below). Multiple photoactivation levels/phototagging colors can be used to multiplex cell populations.

FIG. 4D indicates removing at least a fraction of the cells from the holding space. The tagged objects 9C and non-tagged objects 9A may be discerned and/or identified for further use and/or analysis, which may include quantifying like counting. FIG. 4E indicates optional sorting of the removed cells on the basis of the phototags e.g. on the basis of the activation or not of the phototags and/or or on an amount of activation, dependent on the type of dye and/or phototagging method.

Steps 4C and 4D (possibly also 4E) may be repeated several times, e.g. wherein in each repetition the acoustic force is increased a predetermined amount so that fractions of cells detached at a particular force but not detached at a lower force may be identified.

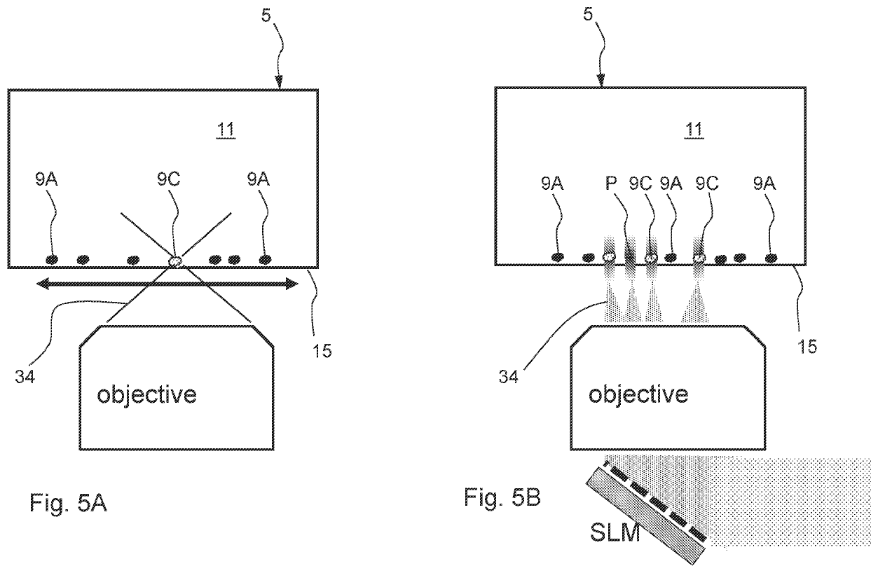

FIGS. 5A-5B indicate different methods of phototagging objects in particular tagging positions along a wall 15 of a holding space 5, by focusing phototagging light on selected objects, individually as shown or as groups of objects, e.g. groups of objects near each other (not shown). A particular relation between the tagging position and the force at the tagging position may be established before and/or after the phototagging. The determination may comprise determining a desired/intended value and/or a resultant/actual value of the force at the tagging position, which value may comprise or be a relative value and/or an absolute value.

FIG. 5A indicates relative lateral movement of a focusing lens, e.g. a microscope objective, and (a holding space of a) sample holder containing the objects to facilitate the selection.

FIG. 5B indicates positioning a focus of phototagging light to facilitate the selection by modifying a light beam relative to a focusing lens, here using a spatial light modulator (SLM) determining plural foci, subsequently and/or simultaneously as shown. FIG. 5B also indicates a tagging position P where no object, at least no taggable object 9, is located.

Other systems and/or methods of displacing one or more foci and/or modifying an optical intensity pattern with respect to the holding space may also be used, e.g. using one or more of electro-optical and/or acousto-optical modulators, adjustable reflectors, etc.

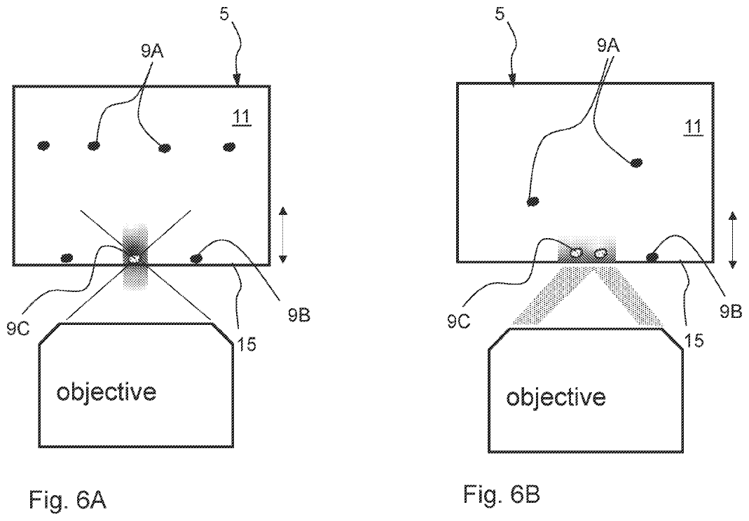

FIGS. 6A-6B indicate different methods of phototagging objects in particular tagging positions at a particular depth in the holding space 5, by focusing phototagging light on selected objects, individually or as groups of objects near each other. FIG. 6A indicates relative movement of a focusing lens, e.g. a microscope objective, and (a holding space of a) sample holder containing the objects 9 (9A-9C) in a direction along a direction of propagation of the light to facilitate the selection by positioning the focus at a predetermined position in the holding space. Thus, selected objects 9C not displaced into the fluid 11 (and attached to the wall 15) may be phototagged whereas other objects may selectively be left untagged such as objects 9B having experienced an undesired amount of force and even though not displaced into the fluid 11, and objects 9A detached and displaced into the fluid 11. Thus, only the strongly-bound objects 9C of which the bonding strength is larger than a predetermined acoustic force are phototagged in this example.

FIG. 6B indicates using an evanescent light field from light directed into the wall 15 of the holding space 5, e.g. using the wall 15 as a light guide and/or a reflector, so that phototagging light is localised close to the wall of the holding space. Thus, objects 9C remaining on, or staying close to, the wall 15 may be phototagged whereas objects 9A displaced into the fluid, and/or objects 9B remaining on, or staying close to, the wall 15 but not having been subjected to the desired amount of force are not tagged.

Combinations of two or more photoaging techniques of FIGS. 5A-6B may be combined sequentially and/or simultaneously, Accurate determination of a tagging position may be improved by using multiphoton tagging, wherein different techniques may be used to define different and overlapping optical intensity profiles defining local intensity maxima and/or -minima.

The disclosure is not restricted to the above described embodiments which can be varied in a number of ways within the scope of the claims.

For instance the holding space may have a different shape. Objects in one sample may be of mutually different types; then, objects of different types, in particular objects of optically detectably different types may have the same phototags.

Elements and aspects discussed for or in relation with a particular embodiment may be suitably combined with elements and aspects of other embodiments, unless explicitly stated otherwise.

1. A method of manipulating objects comprising:
providing a sample holder comprising a holding space for holding an at least partly fluid sample;
providing a sample comprising one or more of the objects in a fluid medium in the holding space;
controllably causing a local variation of one or more conditions for the objects in at least part of the holding space;
removing at least a fraction of the objects from the holding space;
determining a spatial dependency of the local variation; and
phototagging on a basis of the determined spatial dependency at least part of the objects in the holding space in one or more tagging positions thus providing tagged objects, and
wherein the step of removing at least a fraction of the objects from the holding space comprises removing at least part of the tagged objects.

2. The method according to claim 1, wherein the method comprises determining values of the local variation, and wherein the one or more tagging positions (P) are selected on a basis of a predetermined value and/or range of values.

3. The method according to claim 1, wherein the one or more conditions comprise one or more of mechanical conditions, acoustic conditions, electromagnetic conditions, thermal conditions, a concentration of a (bio-) chemical substance and a number or concentration of objects; and/or
wherein the local variation provides, one or more of: a mechanical force, a pressure force, an acoustic force, an electromagnetic force, a temperature change, a (bio-) chemical reaction trigger, a (bio-) chemical substance concentration variation, and a biological substance concentration variation; and/or
wherein the local variation is configured to induce displacement of at least part of the objects relative to a portion of the holding space.

4. The method according to claim 1, comprising providing at least some of the objects with a tagging substance having an optical property that is alterable by illumination in one or more predetermined wavelength ranges, and
wherein the phototagging comprises illuminating the at least part of the objects in the holding space in the one or more tagging positions with light having a wavelength in the one or more predetermined wavelength ranges and altering the optical property.

5. The method according to claim 1, comprising providing at least part of the objects with one or more tagging substances enabling independent and/or multiple phototagging, and phototagging on a basis of the determined spatial dependency one or more of the objects provided with one or more tagging substances plural times and/or on plural tagging positions.

6. The method according to claim 1, wherein the step of phototagging is performed prior to the step of controllably causing a local variation of one or more conditions for the objects in at least part of the holding space; or
wherein the step of phototagging and the step of controllably causing a local variation of one or more conditions for the objects in at least part of the holding space are performed at least in part simultaneously.

7. The method according to claim 1, comprising providing the holding space with a functionalised wall surface portion to be contacted by at least part of the sample.

8. The method according to claim 7, wherein the step of controllably causing a local variation of one or more of the conditions comprises subjecting the objects to a driving force for displacing at least some of the objects with respect to a portion of the holding space, wherein the driving force is configured for urging the objects in a direction away from the functionalised wall surface portion, when provided.

9. The method according to claim 1, wherein the step of controllably causing a local variation of one or more of the conditions comprises applying an acoustic wave in the sample holder for applying an acoustic force to the at least part of the objects in the holding space.

10. The method according to claim 1, further comprising determining an active area in the holding space and determining one or more tagging positions in the active area, and/or wherein the holding space comprises a holding space depth and the method comprises defining one or more tagging positions in a predetermined depth or range of depths within the holding space depth.

11. The method according to claim 1, comprising repeating one or more times the steps of causing a local variation of at least one of the conditions for subjecting in at least part of the holding space at least part of the objects in the holding space to the local variation of the one or more conditions, and removing at least a fraction of the objects from the holding space,
wherein the step of phototagging is executed in between and/or during at least some successive instances of performing the steps of causing a local variation, and
wherein in at least one repetition the step of causing a local variation of at least one of the conditions for subjecting in at least part of the holding space at least part of the objects in the holding space to a local variation of the one or more conditions may differ from a preceding execution of the step.

12. A computer implemented method of manipulating objects in a fluid medium comprising the steps of:
receiving data representing one or more conditions for objects in a fluid medium in a holding space of a sample holder;
receiving data representing a local variation in the one or more conditions for the objects in the holding space;
determining a spatial dependency of the local variation;
determining on a basis of the determined spatial dependency one or more tagging positions (for at least part of the objects in the holding space;
providing a control signal for a controllable light source for phototagging at least part of the objects in the holding space in the one or more tagging positions thus providing tagged objects;
providing a control signal for an actuator for controlling a fluid flow through the holding space for removing at least a fraction of the tagged objects from the holding space.

13. Data processing apparatus comprising means for carrying out the method of claim 12.

14. A computer program comprising instructions which, when the program is executed by a computer, cause the computer to carry out the method of claim 12.

15. A computer-readable medium having stored thereon the computer program of claim 14.

16. A system comprising:
a sample holder comprising a holding space for holding an at least partly fluid sample comprising one or more objects;
an acoustic wave generator connectable or connected with the sample holder to generate an acoustic wave in the holding space exerting a force on at least part of the sample;
a fluid supply for supplying at least part of an at least partly fluid sample to the holding space and/or for removing at least a fraction of the at least partly fluid sample from the holding space; and
a light source for phototagging sample objects in the sample fluid in the holding space in one or more tagging positions thus providing tagged objects; and
a computer operably coupled to the acoustic wave generator, the fluid supply and the light source, the computer configured to:
receive data representing one or more conditions for objects in a fluid medium in the holding space of the sample holder:
receive data representing a local variation in the one or more conditions for the objects in the holding space;
determine a spatial dependency of the local variation;
determine on a basis of the determined spatial dependency one or more tagging positions for at least part of the objects in the holding space;
provide a control signal for the light source for phototagging at least part of the objects in the holding space in the one or more tagging positions thus providing tagged objects; and
providing a control signal for fluid supply for controlling a fluid flow through the holding space for removing at least a fraction of the tagged objects from the holding space.

17. The system according to claim 16, wherein the sample holder comprises a wall providing the holding space with a functionalized wall surface portion to be contacted, in use, by at least part of the sample; and/or
wherein the acoustic wave generator is configured to exert a force on the one or more objects, such as cellular bodies, of the sample in the holding space, when comprised in the holding space, in a direction away from a wall of the holding space,
when provided.

18. The system according to claim 16, comprising an optical detector for optically detecting at least some objects of the sample in the holding space.

19. (canceled)
